(19) United States
(12) Patent Application Publication
(10) Pub. No.: US 2023/0012110 A1
(43) Pub. Date: Jan. 12, 2023

(54) AUTOMATED ELECTRONIC ACCOUNT MANAGEMENT PLATFORM USING MACHINE LEARNING

(71) Applicant: Citizens Financial Group, Inc., Providence, RI (US)

(72) Inventors: Benjamin Adam Fish, Charlotte, NC (US); Nathaniel Hickok Bacon, Chadds Ford, PA (US); Andrew Kamron Rostami, Weston, MA (US)

(73) Assignee: Citizens Financial Group, Inc., Providence, RI (US)

(21) Appl. No.: 17/849,934

(22) Filed: Jun. 27, 2022

Related U.S. Application Data
(60) Provisional application No. 63/218,989, filed on Jul. 7, 2021.

(51) Int. Cl. G06Q 30/02; G06Q 40/04; G06N 20/00

(52) U.S. Cl. CPC G06Q 30/0232; G06Q 40/04; G06N 20/00

(57) ABSTRACT

A system comprises a user device associated with a user and a server in communication with the user device. The server generates an interactive graphical user interface (GUI) comprising one or more interactive screens for display on the user device and receives, from the user device via the interactive GUI, user input indicating user characteristics and stock rewards characteristics specific to the user. In response, the server creates an electronic credit card and a linked brokerage account. The server monitors data from at least one card processor system and/or at least one entity system for changes in the user's transaction activity and/or non-transaction activity. The server determines a stock rewards value to be applied to the brokerage account based on the monitored data and automatically initiates a brokerage transaction, funded by a stock rewards balance in the brokerage account, in accordance with the stock rewards characteristics associated with the user.

### CROSS REFERENCE TO RELATED APPLICATION

This application claims benefit to U.S. Provisional Application No. 63/218,989, filed Jul. 7, 2021, entitled “SYSTEM AND METHOD FOR CUSTOMIZABLE STOCK BACK CREDIT CARD”, the disclosure of which is incorporated herein by reference in its entirety.

### TECHNICAL FIELD

The present disclosure generally relates to improving electronic account handling and, in particular, to management systems, interactive graphical user interfaces (GUIs) and methods for the management of credit cards linked to customizable stock rewards to reflect monitored and predicted user activity across multiple electronic entity systems.

### BACKGROUND

Conventional account management systems are limited in many ways. For one, these systems are limited to capturing and/or tracking only certain types of user activity data, namely, the type of activity data that directly involves the accounts being managed. For example, in a credit card account management system, only transactions (e.g., credit card purchases) involving the credit card accounts being managed are captured by the credit card account management system. Data pertaining to other user activity, such as activity that does not involve a managed credit card account, activity that does not involve any type of purchase, activity involving other types of accounts are not captured. Indeed, existing account management systems, including credit card account management systems, lack the connectivity to other external systems and the technology (e.g., specialized computer components, logic, machine learning, network topology, security, etc.) to capture and/or process other types of user activity data from other types of systems.

Moreover, existing account management systems are unable to intelligently model and/or predict user behavior and/or interests. This is due, at least in part, to the inability of existing account management systems to capture anything other than transaction data involving a managed account, as noted above. As a result, existing account management systems are unable to proactively suggest, promote, incentivize and/or reward user activity that may align with each particular user's profile. Instead, existing account management systems are limited to offering reactive rewards that are based exclusively on a user's transaction activity (e.g., purchases). This too is a direct result of a lack of infrastructure and technology.

Further still, to the extent that existing account management systems to offer (reactive) rewards, such rewards are limited to “cash back” or “redeemable points” that are calculated as a percentage of a value of a user's transaction activity. Existing account management systems lack the infrastructure and technology to offer, for example, other types of incentives or rewards, particularly those that generated by and/or in connection with completely independent systems.

Accordingly, there is a need for a new type of account management system that has the infrastructure and technology to communicate with and retrieve activity data from any number of independent (non-account management) systems. There is also a need for a new type of system that is capable of processing and/or modeling data from the independent systems in order to intelligently determine a user's profile, proactively suggest, promote, incentivize and/or reward user activity based on the user's profile and/or on the activities of others having similar behavior profiles, and offer incentives and/or a new type reward that may be generated by or in connection with one or more independent systems. This new type of system should also be able to continually evolve with each particular user's profile, such that the system's proactive suggestions, promotions, incentives and/or rewards conform to each user's then-current profile.

### SUMMARY

Aspects of the present disclosure relate to systems, methods and non-transitory computer-readable mediums for capturing and modeling user activity data from multiple data sources, and in turn, managing electronic user accounts in consideration of each user's particular and evolving activity profile. A system includes at least one user device associated with at least one user and at least one server in communication with the at least one user device. The at least one server is configured to generate an interactive graphical user interface (GUI) comprising one or more interactive screens for display on the at least one user device. User input received by the at least one server from the at least one user device via the interactive GUI may indicate user characteristics and stock rewards characteristics specific to the at least one user. Responsive to receiving the indicated user characteristics and the stock rewards characteristics, the at least one server is configured to create an electronic credit card and a brokerage account linked to the electronic credit card, both of which are associated with and customized to the at least one user according to the user input.

The at least one server is further configured to monitor data from among one or more of at least one card processor system and at least one entity system for any changes in user activity associated with the at least one user, the user activity including a combination of transaction activity and non-transaction activity. Then, based on the monitored data, the at least one server determines a stock rewards value to be applied to the brokerage account, and automatically initiates a brokerage transaction, funded by a stock rewards balance in the brokerage account, in accordance with the stock rewards characteristics associated with the at least one user.

In some aspects, the at least one server uses machine learning to learn and update a user's profile (e.g., user and stock reward characteristics specific to the user), to make recommendations or suggestions to the user. For example, the at least one server may model the user's current and historical activity and/or the activity of other users to determine and suggest or recommend to the user categories of stock rewards the user may be interested in selecting and activities the user may be interested in. As the user's profile changes, the system-generated recommendations or suggestions may also change, so as to evolve with the user.

### BRIEF DESCRIPTION OF THE DRAWINGS

FIG. 1 is a schematic illustration of an exemplary electronic account management system according to an aspect of the present disclosure.

FIG. 2 is a flowchart diagram of an exemplary opening process implemented by an electronic account management system according to an aspect of the present disclosure.

FIG. 3 is a flowchart diagram of an exemplary onboarding process that may be performed by components of an electronic account management system according to an aspect of the present disclosure.

FIGS. 4A-4B show a flowchart diagram of an exemplary process for determining and awarding stock rewards by components of the electronic account management system according to an aspect of the present disclosure.

FIG. 5A is a screenshot of an exemplary interactive display screen showing a welcome screen configured to guide a user to a series of additional interactive screens collect user profile and/or activity data and information according to an aspect of the present disclosure.

FIG. 5B is a screenshot of an exemplary interactive display screen showing a user's accumulated stock rewards and preferences, and a function for launching one or more additional interactive screens, according to an aspect of the present disclosure.

FIG. 5C is a screenshot of an exemplary interactive display screen showing a system-generated incentive message and the user's progress towards satisfying the incentive, according to an aspect of the present disclosure.

FIG. 5D is a screenshot of an exemplary interactive display screen showing system-generated suggestions for engaging in non-transaction activities according to an aspect of the present disclosure.

FIG. 5E is a screenshot of an exemplary interactive display screen confirming ownership of a full share of a particular stock purchased using earned stock rewards according to an aspect of the present disclosure.

FIG. 5F is a screenshot of an exemplary interactive display screen showing that a particular lifestyle goal of a user has been achieved, according to an aspect of the present disclosure.

FIG. 6 is a functional block diagram of an example computer system according to an aspect of the present disclosure.

### DETAILED DESCRIPTION

The present disclosure generally relates to systems, methods and non-transitory computer-readable medium for (among other things) capturing and modeling user activity data from multiple data sources, and in turn, managing electronic user accounts in consideration of each user's particular and evolving activity profile. To that end, systems of the present disclosure are uniquely configured for, among other things, monitoring real time user activity (e.g., user transactions, non-transaction activity, etc.) across any number of independent systems via one or more networks, creating and managing user-customizable accounts (e.g., credit cards linked to user-customizable stock rewards), intelligently modeling and predicting user activity (e.g., using machine learning processes), generating engagement suggestions based on modeled and/or predicted user activity, rewarding users according to their activity engagements, and providing interactive graphic presentations that facilitate real time user interactions. In an exemplary implementation, a system according to the present disclosure may be accessible via a user's mobile communication device (such as via a client application on the user's device), although it may also be accessible via other types of devices and communication means.

In addition, systems of the present disclosure may be adaptive, insofar they may comprise certain features and functions designed to vary over time according to any number of factors, including, for example, changes in the activities and/or preferences of a particular user and/or changes in the activities and/or preferences of a combination of multiple users having similar activity profiles.

Further still, the present disclosure describes new technology and a new infrastructure for creating and offering new types of activity-based rewards. In a non-limiting exemplary implementation, a system according to the present disclosure may be specifically configured for creating and managing user-customizable stock back credit card accounts. Such a system may comprise suitable interfaces and connectivity to interact with and procure real-time data from any number of independent systems (e.g., brokerage systems, card processor systems, merchant entity systems, etc.) across one or more networks.

Systems of the present disclosure may also connect to and generate instructions to cause other, independent systems to perform functions on behalf of users. This may include, for example, automatically instructing an independent brokerage system to initiate brokerage transactions involving user-selected or system-selected shares (and/or fractional shares) of stock, including in real time and/or near real time, on behalf of users. The brokerage systems may use stock rewards awarded based on a combination of transaction and non-transaction activities, without requiring any direct funding from the users.

In addition, systems of the present disclosure may automatically and proactively engage users (e.g., via an interactive GUI, notices, alerts, etc.), including in real time (and/or near real time), thereby providing users with the ability to monitor and/or edit profile data, receive system-generated suggestions and/or options based on modeled and/or learned user activity tendencies, be prompted to engage in certain activities (e.g. transaction/non-transaction) with various entity systems, etc. Systems of the present disclosure also provide the ability to intelligently predict user activity, and in that regard, take automated action to aid users in achieving one or more goals (whether learned by the system and/or input by users) that are specific to each user (e.g., saving for a wedding, saving for college, etc.), for example, by recommending or suggesting transaction/non-transaction activities (e.g., based on system-learned and/or modeled user activity) in a matter that aligns with the profile of each specific user. In this respect, systems of the present disclosure provide a platform and interaction experience that is customizable and unique to each user, and that evolves intelligently throughout each user's account lifecycle.

In some embodiments, a system according to the present disclosure includes any number of user devices associated with any number of users, a plurality of independent systems (e.g., one or more entity systems, one or more card processor systems, one or more brokerage systems, etc.), and a server in communication with user devices and the independent systems via one or more communications networks. The server may be configured to generate an interactive graphical user interface (GUI) comprising one or more interactive screens for display on at least one of the user devices. User input received by the server from the at least one user device via the interactive GUI may indicate user characteristics and stock rewards characteristics specific to at least one user. Responsive to receiving the indicated user characteristics and the stock rewards characteristics, the server may be configured to create an electronic credit card and a brokerage account linked to the electronic credit card, both of which are associated with and customized to the at least one user according to the user input.

In some embodiments, the server may be further configured to monitor data from among one or more of the independent systems (e.g., at least one card processor system and at least one entity system) for any changes in user activity associated with the at least one user, the user activity including a combination of transaction activity and non-transaction activity. Then, based on the monitored data, the server may determine a stock rewards value to be applied to the brokerage account, and automatically initiate a brokerage transaction, funded by a stock rewards balance in the brokerage account, in accordance with the stock rewards characteristics associated with the at least one user.

In some embodiments, the server, upon receiving a first portion of the user input, may be further configured to combine the first portion of the user input with user input associated with one or more other users to generate training data. This training data may then be utilized to train and execute a machine learning process, whose output includes analytics data. The analytics data may then be used by the server to automatically generate one or more actionable prompts that are displayed on the interactive GUI. Selecting or activating one or more of the actionable prompts by the user may then result in a second portion of the user data being automatically transmitted to the server. In this manner, the system intelligently solicits relevant data from the user.

In some examples, the one or more prompts may comprise one or more categories of stock rewards characteristics, for example. In such examples, selecting (by the user) of a particular category of stock rewards characteristics may result in the user earning stock rewards associated with the selected category.

In some embodiments, the server may be further configured to continually monitor activity data from among the independent systems, where the activity data may be associated with the at least one user and any other user of the system. Responsive to detecting at least one change in the user activity associated with the at least one user, the server may be configured to automatically update profile data associated with the at least one user and/or system-generated suggestions or recommendations based on activity of other users having similar profiles.

In some embodiments, the server may be configured to determine a usage of the system by the at least one user of said system. Usage may be categorized as time spent by the user using system functions, a frequency of log-ons to the system by the user, a cumulative length of time the system managed an account of the user, sizes and types of the user's accounts managed by the system, etc. In response to determining usage, the system may automatically award an incremental or enhanced value to determined stock rewards values to the user. In some examples, the user's usage may be determined based on a combination of the user's current usage data and the user's historical usage data over a predetermined period, where the historical usage may be stored in a system memory. In this manner, the system is able to reward loyal and/or high-frequency users.

In some embodiments, the server may be configured to generate and display real-time (or near real-time) updates to the user. The updates may relate to the user's profile data, usage, earned stock rewards, user activity, etc.

In some embodiments, the server may be configured to use machine learning processes to learn a user's tendencies as well as the tendencies of other users that may have similar profiles; and in turn, adapt system-generated suggestions or recommendations to each specific user. In some examples, this may include monitoring activity data associated with one or more other users, and storing the activity data associated with the one or more other users in a database. Capturing the at least one user's current activity data (and/or the at least one user's historical activity data) and combining it with the activity data associated with the one or more other users to create training data. The training data may then be used to train one or more machine learning models as part of a machine learning process to generate analytics data reflective of the at least one user and/or other uses having similar profiles. The analytics data may then be used by the server to automatically generate and display one or more suggestions or recommendations to the at least one user via the interactive GUI. In some examples, completion of one or more of the system-generated suggestions or recommendations may result in additional stock rewards values being awarded to the at least one user. In this manner, the server is able to incentivize users with suggestions or recommendations that the at least one user is likely to complete. In some examples, the one or more suggestions or recommendations may be arranged on the interactive GUI according to a frequency at which each suggestion or recommendation is completed. The frequency may be determined by extracting and analyzing historical usage data from memory, for example.

In some examples, the server may be configured to continually monitor the activity data of the at least one user and/or one or more other users, automatically update the training data and re-execute the machine learning process upon detecting a change in any of the monitored activity data, and automatically generate and display updated suggestions or recommendations based on output of the re-executed machine learning process. In some examples, the updated suggestions or recommendations may also be arranged on the interactive GUI according to a frequency at which each updated suggestion is completed.

In some embodiments, the server may be configured to automatically generate and transmit an alert to the at least one user device upon the occurrence of an update to available stock rewards, an availability of or a change to one or more system-generated suggestions or recommendations, a change in monitored data associated with the at least one user, a change in user activity data associated with one or more other users, a goal progressing of the at least one user, a change to one or more of the user characteristics and the stock rewards characteristics, a status of the brokerage transaction and/or any other update that may be relevant to a user's account(s).

In some embodiments, the system-generated suggestions or recommendations may include engagement activities, the completion of which results in earned stock rewards. The engagement activities may include system-generated incentive or promotional activities, transactional and/or on-transactional activities, etc. Completion of one or more of the system-generated suggestions or recommendations may result in an incremental stock rewards value proposition. In some examples, the suggestions or recommendations may be associated with a particular merchant, and completion of such a suggestion or recommendation may result in a direct fractional stock award from that particular merchant.

In some embodiments, the stock rewards value may be fixed or variable, depending on any number of variable conditions. Similar to the system-generated suggestions or recommendations, the stock rewards values determined by the server may also evolve over time, so as to adapt to changes in each user's profile.

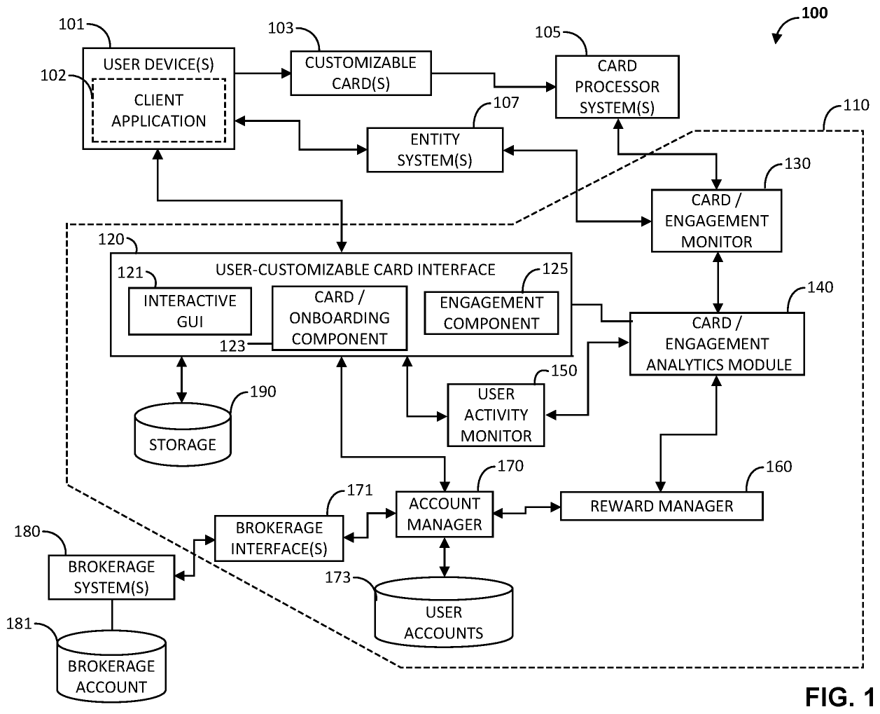

Referring now to FIG. 1, an electronic account management system 100 (also referred to herein as “management system”) for managing one or more electronic credit cards 103 linked to customizable stock rewards (also referred to as user-customizable stock back credit card(s)), according to an aspect of the present disclosure, is shown. In one implementation, the management system 100 may include one or more central main servers 110 comprising a user-customizable card interface 120, a card and engagement (card/engagement) monitor 130, a card and engagement (card/engagement) analytics module 140, a user activity monitor 150, a rewards manager module 160, an account manager module 170, one or more electronic brokerage accounts 181, one or more brokerage interface(s) 171 and storage 190.

The user-customizable card interface 120 may itself include an interactive graphical user interface (GUI) 121, a credit card and onboarding (card/onboarding) component 123 and an engagement component 125. As discussed below, the interactive GUI 121 of the present disclosure may provide engagement and communications opportunities that may provide insight to the user regarding everyday spending, stock growth and/or saving towards a user-specific lifestyle goal. The interactive GUI 121 may also provide information on the user's everyday spending, the user's transaction profile, stock portfolio transparency and growth awareness. Further still, the interactive GUI 121 may provide personalized, artificial intelligence (AI) driven merchant-funded offers which may accelerate stock savings. In some examples, the interactive GUI 121 may provide milestone messaging as it relates to one or more investments, as well as the user-s desired lifestyle goal(s).

The main server(s) 110 of the management system 100 may be configured to communicate with one or more user devices 101 (e.g., via the user-customized card interface 120), one or more entity systems 107 (e.g., via the card/engagement monitor 130), and one or more brokerage system(s) 180 (e.g., via the brokerage interface(s) 171). In some embodiments, the one or more brokerage system(s) 180 and/or its functionality may be included in and be a part of the management system 100.

As illustrated in FIG. 1, the management system 100 may comprise a network of systems and devices, such as user device(s) 101 and other systems (e.g., card processor system(s) 105, entity system(s) 107, brokerage system(s) 180, and others not shown), all of which are in communication with the one or more server(s) 110 of the management system 100. Optionally, components of the management system 100 may be embodied on a single computing device. In other examples, components of the management system 100 may be embodied on two or more computing devices distributed over several physical locations, connected by one or more wired and/or wireless links. It should be understood that the management system 100 of the present disclosure refers to a computing system having sufficient processing and memory capabilities to perform the specialized functions described herein. For example, as discussed further below, the management system 100 may use artificial intelligence (AI) algorithms to determine/predict user activity, provide suggestive alerts, notices and/or one or more engagement activities, and all such indications may be communicated to the user via one or more of email, text message or any suitable form of communication.

In operation, the management system 100 may be configured to generate a unique interactive (GUI) 121, accessible via one or more user devices 101 (e.g. via a client application 102). This interactive GUI 121 may be configured to receive as input user information and data for creating a credit card/account having stock rewards, including user-customizable parameters for configuring the account and/or stock rewards. In some examples, the management system 100 may prompt the user for information (e.g., via a survey, text message questions, etc.) and/or it may monitor, collect and analyze user activity (discussed below) in order to determine (among other things) user profile data comprising user-specific characteristics (e.g., user-specific financial goals, user spending habits, purchase profile/seasonality, etc.) and/or user-specific stock rewards characteristics (e.g., desired stock, desired stock characteristics/categories, desired stock rewards distribution, etc.).

Alternatively or additionally, the management system 100 may collect and store user profile data of one or more other users, and when a current user accesses the management system 100, engages in transaction and/or non-transactional activity (discussed below), and/or at any other system-determined time, the current user's activity data may be captured, combined with profile data that has been previously collected and stored (e.g., from the current user and/or from the one or more other users), and used to update and/or adjust the current user's profile data. Thus, the management system 100 may determine user and stock rewards characteristics through one or more of direct user input via the interactive GUI 121 (e.g., responsive to automated prompts generated and transmitted by the management system 100) and/or via artificial intelligence (AI)/machine learning which includes capturing, analyzing and modeling a current user's activity and/or the activity and profile data of other users.

In some examples, the management system 100 may include a card/onboarding component 123 that may be configured to create the user-customized stock back credit card 103 and/or associated accounts 173 (collectively, ‘stock back credit card’ or simply ‘credit card’). The card/onboarding component 123 may include one or more automated routines (e.g., an onboarding process) to obtain user input in order to create and open the user-customized stock back credit card 103 (e.g., an opening process), determine user activity and/or assign one or more predetermined values to one or more stock rewards to be linked to the credit card 103 (e.g., an onboarding process). In one implementation, predetermined value(s) assigned to the stock reward(s) may be fixed and/or may vary (e.g., depending on user activity, transaction type, non-transaction type, and/or any other suitable condition or conditions that may be set by the management system 100 and/or the user). In some examples, the card/onboarding component 123 may be used, via the interactive GUI 121, by the user to input adjustments to the stock rewards characteristics, properties of the card, user information, stock preferences, and the like over the lifetime of the stock back credit card 103 (e.g., as part of a post-onboarding process).

In an exemplary implementation, the management system 100 may award stock rewards in the form of fractional shares of one or more stocks, such as fractional shares of an equity fund, fractional shares of an exchange traded fund (ETF) and the like. In some examples, the stock reward(s) may be awarded in the form of fractional stock shares of which the cost or value reflects a specific percentage of a volume of a user's transactions (e.g., a percentage of a value of total purchases).

In some embodiments, the interactive GUI 121 may be configured to receive input that enables a user to select one or more desired stocks, including personalization of stock selections based on the user's specific interests, beliefs, prior selections, characteristics, demographics, and the like. The interactive GUI 121 may also be configured to receive input that enables the select how the user's stock rewards are allocated. For example, if a particular user has an interest in ‘green’ technology (e.g., technology that advances efforts for environmental sustainability), the interactive GUI 121 may generate and display system-generated suggestions and/or options on a screen of the user's device 101 for selecting a category of stock rewards (e.g., in an ETF, an equity fund, etc.) that pertain to one or more companies relating to green investments. The interactive GUI 121 may also generate and display system-generated suggestions and/or options for selecting how earned stock rewards should be allocated (e.g., allocate 100%, 50%, 25%, etc. of earned rewards to green technology ETFs). Stock rewards made available for each user may vary based on any number of factors. Non-limiting examples of these factors may include user activity, a type/category of fractional shares previously purchased, a user's profile data (e.g., the user's particular goals, user demographics, etc.).

In some embodiments, the available and/or recommended stock rewards may be configured to vary (e.g., within a same category or into a new category) and evolve over time (e.g., based on one or more predetermined and/or learned conditions). For example, as noted above, the one or more servers 110 of the management system 100 may continuously and/or repeatedly capture user activity and/or profile data (e.g., user and stock rewards characteristics) as it occurs and/or becomes available from any number or subset of users (e.g., via interactive GUI 121, user activity monitor 150, etc.). This captured activity and/or profile data may then be stored in storage 190 (e.g., memory, a database, etc.) for later access and/or it may be used immediately to generate available and/or recommended stock rewards information for a current user and/or for any other users (including those that are not actively logged into or accessing the management system 100).

By way of illustration, current user activity (e.g., accessing the management system's 100 user-customizable card interface 120, making a purchase, enrolling in a third-party entity system, etc.) and/or profile data from among one or more other users may trigger the management system 100 to interrogate the system's storage 190 to access user activity and/or profile data that was previously captured and stored. The current user activity and/or profile data may then be combined with the activity and/or profile data retrieved from storage 190 to create updated user activity and/or profile data. The updated user activity and/or profile data may then be used as training data to feed one or more machine learning models embodied in the one or more servers 110 of the management system 100. The updated user activity and/or profile data may also be stored in storage 190 for later access and use. Optionally, the current user activity and/or profile data may be used directly (e.g., without combining it with previously-captured data) as training data for the one or more machine learning models.

Output from the one or more machine models may include available and/or recommended stock rewards information that evolves over time according to usage (e.g., how often users having a similar profile select a particular stock reward), performance (e.g., in the stock market), eligibility (e.g., whether the user engaged in required activity) and/or any other basis. The stock rewards (and related information) may then be displayed in a selectable manner to any number of users (including active users and those not currently logged into or access the management system 100) via the interactive GUI 121.

In some embodiments, the stock rewards and related information may be displayed in a manner that indicates which stock rewards are available, which are most often selected, which are the most aligned with a user's particular profile, or in any other manner. As new or additional user activity and profile data is captured (e.g., which may occur continuously, periodically and/or at predetermined intervals), the management system 100 may repeatedly or continuously extract previously-captured user activity and/or profile data from storage 190, further update it with the newly captured data, and use the further updated data to execute the one or more machine learning models. Updating the user activity and profile data in this manner improves the training data by ensuring that it includes the must current and relevant activity and/or profile data. Improved training data in turn improves the modeling process (including the one or more machine learning models) and the overall management system 100. Output from the one or more machine learning models may then be used to update the stock rewards information displayed to the user via the interactive GUI 121.

In some embodiments, updates to the stock rewards information being displayed (e.g., on a user device's display) may occur in real time, as the user is viewing the stock rewards information. For example, if the stock rewards information is displayed as a selectable list (e.g., with the most frequently user-selected stock rewards on one end of the list and the least frequently user-selected stock rewards on another end of the list), the continuous and/or repeated output generated by the one or more machine leaning models may cause the interactive GUI 121 to rearrange and/or update the list to reflect changes in the frequency at which users select certain stock rewards. The modeling output may also cause the interactive GUI 121 to change or rearrange how the stock rewards are displayed to indicate, for example, that certain stock rewards are no longer available, that new stock rewards are now available, and/or any other change relating to the stock rewards (e.g., value, use, relevance to user's profile, etc.). Frequent or continuous updates to the display of stock rewards (e.g., based on output from the one or more machine learning models), may cause the available and/or selectable stock rewards to appear ‘live’ and evolving.

In some embodiments, the user-customizable card interface 120 may include an engagement component 125. The engagement component 125 may be configured to automatically generate engagement activity suggestions or recommendations (e.g., based on machine learning modeling) to incentivize a user to interact (or engage) with one or more entity systems 107 to perform one or more engagement activities, such as transactions and/or non-transaction actions. In some embodiments, the management system 100 may fund one or more promotions (e.g., transaction and/or non-transaction incentive) with various entity system(s) 107 to generate engagement activities. A transaction incentive may include, for example, an offer (e.g., from a merchant entity system) to reward a user with shares of stock of a particular merchant if the user spends $X within Y days at that merchant. In some embodiments, the merchant entity system may offer different levels of stock rewards. In some embodiments, the stock of the particular merchant may be awarded to the user in addition to stock rewards that are based on the value of the purchase, for example.

For purposes of this disclosure, ‘non-transaction’ actions refer to activities or actions that may not necessarily involve a purchase, sale or exchange transaction involving a credit card. Examples of non-transaction actions include, without limitation, engagement activities such as adding one or more authorized users to an existing account, setting up an online banking account with an entity system, setting up an automatic bill pay process with an entity system (e.g., merchant or service provider system), enrolling in a new type of entity account, etc. As will be appreciated, none of these engagement activities involves the purchase, sale or exchange of a good or service. Nonetheless, in some embodiments, participating in and/or completion of non-transaction engagement activities may also be tied to (and result in) one or more stock rewards offers. For example, a non-transaction incentive may include an offer to a user to engage in one or more of these activities in order to receive stock reward(s).

In some embodiments, the engagement component 125 may comprise one or more machine learning models configured generate the one or more engagement activity suggestions or recommendations based on a machine learning process. For example, the one or more servers 110 of the present management system 100 may continuously and/or repeatedly capture user activity and/or profile data as it occurs from any number or subset of users (e.g., directly via interactive GUI 121, user activity monitor 150, etc.). The captured activity and/or profile data may then be stored in storage 190 (e.g., memory, a database, etc.) for later access and/or it may be used immediately to generate one or more engagement activity suggestions or recommendations for a current user and/or for any other users of the management system 100 (including those that are not actively logged into or accessing the management system 100).

Capturing user activity and/or profile data may trigger the management system 100 to interrogate the system's storage 190 to access user activity and/or profile data that was previously captured and stored. The currently-captured user activity and/or profile data may then be combined with the previously-captured activity and/or profile data retrieved from storage 190 to create updated user activity and/or profile data. The updated user activity and/or profile data may then be used as training data to feed one or more machine learning models comprising the engagement component 125. The updated user activity and/or profile data may also be stored in storage 190 for later access and use. Optionally, the currently-captured user activity and/or profile data may be used directly (e.g., without combining it with previously-captured data) as training data for the one or more machine learning models comprising the engagement component 125.

Output from the one or more machine learning models may be used by the engagement component 125 to generate available and/or recommended or suggested engagement activities that, if performed, may yield one or more stock rewards for a user. As with available or suggested stock rewards recommendations, engagement activity recommendations may also evolve over time according to usage (e.g., how often users having a similar profile engage in certain engagement activities), eligibility (e.g., whether the user is eligible to engage in the recommended or suggested engagement activity) and/or any other basis. The engagement activity recommendation(s) may then be transmitted and displayed as selectable prompt(s) to any number of users (including active users and those not currently logged into or access the management system 100) via the interactive GUI 121, as part of an email message, a text message, and the like. In some examples, the engagement component 125 may generate and transmit one or more alerts and/or notifications indicating, without being limited to, any updates in available stock rewards incentives, stocks (and/or fractional shares) purchased, stock values, current and/or predicted user activity, changes in user activity, goal progress indications, and the like. Frequent or continuous updates to the display of engagement activity recommendations (e.g., based on output from the one or more machine learning models) may cause the available and/or selectable engagement activity recommendations to appear ‘live’ and evolving.

In some embodiments, user-customizable card interface 120 may further include a card/onboarding component 123. The card/onboarding component 123 may provide onboarding functionality that enables users to create customizable stock back credit card(s) 103 (and associated account(s) 173), with the ability to change any preferences, including in real time. For example, the card/onboarding component 123 may generate and present to a user (e.g., via the interactive GUI 121) one or more selectable options (e.g., click boxes, drop-down menus, etc.) and/or input fields. These selectable options and/or input fields may collect information about a user's profile (e.g., income, financial objectives, financial profile, etc.), preferences (e.g., preferred stock characteristics, display features, credit card attributes, etc.), transaction activities (past, present and/or future), and the like. Responses and data received by the card/onboarding component 123 may then be used to create a user's personal and activity profiles as part of an onboarding process.

In some embodiments, input received by the card/onboarding component 123 (e.g., one or more user preferences entered via the interactive GUI 121) may cause a change in a user's existing profile data, which may in turn cause a change to one or more engagement activity recommendations generated by the engagement component 125 and/or one or more stock rewards recommendations generated by the management system 100.

Receiving certain user profile and/or activity data (e.g., during the onboarding process facilitated by the card/onboarding component 123) may trigger one or more automated routines to create, for a particular user, a credit card 103, an associated account 173, user profile and activity information (e.g., which may be stored in storage 190) and a brokerage account 181 linked to the credit card 103/user account 173, all in accordance with the specific user's profile and/or activity data. The management system 100 may also trigger one or more automated routines for determining if the user is eligible for stock rewards, whether and when the user has earned stock rewards, and how much value is attributable to stock rewards the user may have earned.

For example, once a customizable credit card 103 has been created for a specific user, and a brokerage account 181 has been created for the specific user and linked to the specific user's credit card 103, the management system 100 may cause the card/engagement monitor 130 to automatically monitor (continuously, repeatedly and/or at predetermined intervals) transaction activity involving the credit card (e.g., via direct communications with one or more card processor system(s) 105 and/or one or more entity systems(s) 107), and non-transaction (e.g., engagements) activities (e.g., via direct communications with one or more entity system(s) 107). In addition, as noted above, the specific user's transactions and non-transaction activities may be monitored (continuously, repeatedly and/or at predetermined intervals) via direct user input via the user-customizable card interface 120 and/or by the user activity monitor 150). In some embodiments, the card/engagement monitor 130 may be a part of the user activity monitor 150.

The monitored transaction and non-transaction activities may be used by the management system 100 to learn and determine credit card and/or engagement analytics associated with the specific user (e.g., via the card/engagement analytics module 140). For example, the card/engagement analytics module 140 may implement one or more modeling processes (e.g., comprising one or more machine learning modules) that use, as training data, monitored transaction and/or non-transaction activity data as input, and outputs credit card and/or engagement analytics. As new or updated transaction and/or non-transaction activity data is monitored, the training data may be updated, and the modeling processes may be re-executed using the updated training data. In this manner, the card/engagement analytics module 140 is able to improve its modeling processes (e.g., by continuously, repeatedly and/or at predetermined intervals updating the data being modeled), which in turn yields constantly-improving analytics data.

The analytics data generated by the card/engagement analytics module 140 may then be used by the management system 100 to assess current user activity and/or predict future user activity. In addition, the analytics data may be used to make stock rewards recommendations and/or intelligently trigger the engagement component 125 to interact with targeted users (e.g., to generate and transmit one or more alerts, notices, suggested engagement activities, etc.).

Output from the card/engagement analytics module 140 may also be used by the management system 100 to determine if the user is eligible for certain stock rewards, whether and when the user has earned stock rewards, and how much value is attributable to stock rewards the user may have earned. This may be accomplished, for example, via the rewards manager module 160. The rewards manager module 160 may receive and/or extract analytics data from the card/engagement analytics module 140, compare the analytics data against one or more predetermined stock rewards conditions, and determine, based on the comparison, whether and which stock rewards the user is eligible for. In some embodiments, predetermined stock rewards conditions may include a minimum/maximum transaction amount, a minimum/maximum number of transactions, whether the user's activity occurred within a predetermined time frame, the particular merchant(s) involved, and any other condition set by the system and/or the user. In some embodiments, satisfying all predetermined conditions may be required to be eligible for certain stock rewards, while for certain other stock rewards, eligibility may be obtained by satisfying a combination of fewer than all predetermined conditions.

The predetermined conditions may themselves be determined and/or updated by the management system 100 based on (current and/or past) user activity. For example, as the user engages in more and/or more impactful activities (whether transactions and/or non-transaction activities), the system may reduce the number and/or type of predetermined conditions needed for eligibility of certain stock rewards. The predetermined conditions may include, for example, current and/or predicted user activity, user characteristics, completion of one or more transactions and/or transaction activities, engagement with certain entity system(s) 107, and/or any other suitable condition. For predetermined conditions that include a user's activity, the user's activity may be captured via one or more of the monitoring components discussed herein and/or directly via user input (e.g., via the interactive GUI 121).

Once the management system 100 determines that the specific user is eligible for one or more stock reward(s), the management system 100, via the rewards manager module 160, may assign one or more predetermined value propositions to one or more transactions and/or non-transaction activities of the specific user for purposes of determining the value of stock rewards to be awarded to the specific user. In some embodiments, the value of stock rewards may be determined as a percentage of the value of the transaction(s) and/or non-transaction activities used to earn the stock rewards, as a fixed (per-activity) amount, as a variable amount (e.g., which changes based on the value and/or quantity of transactions/non-transaction activities), as a percentage of transaction/non-transaction activity value up to a predetermined maximum, as a combination of fixed and variable amounts, and/or based on any other valuation approach.

In some embodiments, the management system 100 may also assign incremental value propositions to the transactions and/or non-transaction activities, in addition to the predetermined value propositions, thereby increasing the overall value propositions for said transactions and/or non-transaction activities. Awarding incremental value propositions may occur, for example, if the transactions and/or non-activity transactions are a part of a promotion and/or in response to system-suggested incentive (engagement) activities. Incremental value propositions may also be assigned based on the user's prior relationship with the issuer of the user-customized stock back credit card 103. For example, having one or more other credit cards, one or more other types of accounts, having purchased other products and services therefrom, etc. may cause the management system 100 to assign incremental value propositions to one or more of the user's transactions and/or non-transaction activities. In addition, as noted above, the user may earn a direct stock reward from a particular merchant (e.g., for engaging in transactions and/or non-transaction activities involving that particular merchant). This direct stock award may supplement the stock rewards value propositions determined by the management system 100, or a value of the direct stock award may be deducted from the value propositions determined by the management system 100.

Once the management system 100 determines a value of stock rewards to be awarded to the user, the management system 100 may automatically initiate one or more brokerage transactions (e.g., via an electronic exchange platform) on behalf of the user (without a need for further input from the user). The one or more brokerage transactions may involve the purchase and/or sale of full shares and/or fractional shares of stock (e.g. fractional shares of an equity fund, fractional shares of an exchange traded fund (ETF) and the like) selected by the user and/or selected by the management system 100 for the user. In some embodiments, the one or more brokerage transactions will be completely funded with the stock rewards awarded by the management system 100 (e.g., as opposed to the user funding such brokerage transactions).

In operation, upon determining the value of stock rewards to be awarded to the user, the management system 100 may automatically initiate communications with one or more brokerage system(s) 180 via, for example, one or more brokerage interface(s) 171. For example, the management system 100 may automatically generate an electronic communication that includes information relating to the value of stock rewards added to the user's brokerage account 181 and/or instructions for initiating one or more brokerage transactions on behalf of the user. The management system 100 may then transit the electronic communication to the one or more brokerage system(s) 180.

In response to receiving the electronic communication, the one or more brokerage system(s) 180 may initiate the one or more brokerage transactions according to the instructions and information included in the electronic communication. The one or more brokerage transactions may be funded using the stock rewards added to the user's brokerage account 181.

In some embodiments, the management system 100 may determine a value of stock rewards for the user in real-time or near real-time (i.e., as the user's transactions and/or non-transaction activities occur and are captured by the management system 100). The initiation of brokerage transactions may also occur in real-time or near real-time (i.e., as soon as the management system 100 determines a value of stock rewards for the user).

In some embodiments, as soon as the brokerage transactions are initiated, information reflecting the brokerage transactions (and their status) may automatically (e.g., in real-time or near real-time) be reflected in the user account 173. The management system 100 may also generate and present information relating to the stock rewards and/or brokerage transactions (e.g., via the interactive GUI 121, via a text message, an email message, an alert, etc.) in real time (or near real time). In this manner the user may obtain an indication of any stock rewards and/or brokerage transactions substantially concurrently with the user's transaction and/or non-transaction activities.

While shares or fractional shares of stock purchased on behalf of the user may be stored in the user's brokerage account 181, the user may nonetheless manage those shares and/or fractional shares of stock via the management system 100 of the present disclosure. For example, the user may initiate one or more ad hoc brokerage transaction requests via interactive GUI 121. In response, the management system 100 may generate one or more electronic communications that include information defining the user's brokerage transaction requests, and transmit the one or more electronic communications to the one or more brokerage system(s) 180 via, for example, the brokerage interface(s) 171. The brokerage system(s) 180 may then initiate the one or more brokerage transactions in accordance with the user's requests. In some embodiments, the brokerage transactions initiated by the user may result in a sale of stocks or fractional shares of stocks, resulting in an amount of equity being credited to the user's brokerage account 181. This equity may then be automatically transferred to the user's user account 173.

Information relating to the brokerage transaction requests, the initiation of the brokerage transactions, the status of the brokerage transactions, updates to the user's brokerage account 181 and/or user account 173 (e.g., resulting from the brokerage transactions), etc. may be captured and reported to the user in real time (or near real-time), and to the management system 100 for access by the user at any time.

In some embodiments, components of the management system 100 may be communicatively coupled via one or more communication networks (not shown). The one or more networks may include, for example, a private network (e.g., a local area network (LAN), a wide area network (WAN), intranet, etc.) and/or a public network (e.g., the Internet).

User devices 101 according to the present disclosure may include, without limit, any combination of mobile phones, smart phones, tablets computers, laptop computers, desktop computers, server computers or any other computing device configured to capture, receive, store and/or disseminate any suitable data. In one embodiment, a user device may include a non-transitory memory, one or more processors including machine readable instructions, a communications interface which may be used to communicate with the management system (and, in some examples, with the entity system(s)), a user input interface for inputting data and/or information to the user device and/or a user display interface for presenting data and/or information on the user device. In some examples, the user input interface and the user display interface may be configured as a graphical user interface (GUI). The user device 101 may also be configured to display the interactive GUI 121 of the management system 100 on the GUI of the user device 101. In some examples, the interactive GUI 121 of the management system 100 may be provided via a client application 102 of the user device.

In some embodiments, the card processor system(s) 105 may include one or more servers configured to process transactions, may communicate with one or more point-of-sale (POS) systems and/or may communicate with any transaction device capable of processing transactions with the stock back credit card. Although not shown, POS systems may comprise any point of sale (POS) device (e.g., embodied as a terminal including hardware and software and/or a software-based system on a mobile device for processing card payments at retail locations) for accepting payment of transactions from users. The POS systems may also correspond to physical places of business (e.g., stores) and/or online websites. In some examples, the card processor system(s) 105 may aggregate transactions from one or more entity systems 107.

The entity systems 107 may include, without being limited to, financial institutions (e.g., a bank entity, a loan service, etc.), business entities (such as a utility company, a telecommunications company, etc.), government entities (e.g., federal agencies, state government agencies, etc.), credit agencies, other users/systems, and/or any suitable source of data and/or information. The entity systems 107 may provide information to the management system 100 upon completion of any predetermined transaction and/or engagement activities prompted by the engagement component 125 of the management system 100, for example. The management system 100 may also be configured to interrogate and/or pull data from the entity systems 107 at predetermined times and/or at any time fresh data is desired. The entity systems 107 may comprise a server computer, a desktop computer, a laptop, a smartphone, a tablet, or any other electronic device configured to capture, receive, store and/or disseminate any suitable data.

Also included in the network 100 are brokerage system(s) 180, which themselves may include any entity system 107 that may function as a liaison to purchase stocks via one or more electronic exchanges. The stocks may be purchased based on the indicated stock rewards on behalf of the specific user, in accordance with instructions generated by and received from the management system 100. The brokerage system(s) 180 may comprise a server computer, a desktop computer, a laptop, a smartphone, a tablet, or any other electronic device configured to provide brokerage actions and provide stock investments to the management system 100 for storage in brokerage account(s) 181. The brokerage accounts 181 may in turn be stored as electronic records in suitable storage. In some examples, the brokerage accounts may be stored in off-site secured storage.

In some embodiments, the management system 100 of the present disclosure may obtain data and/or information from among the systems (e.g., card processor system(s) 105, entity system(s) 107, brokerage system(s) 180, etc.) through one or more live data feeds, through one or more file transfers, including, in some examples, secure file transfer(s), by being pushed to the main server(s) 110 and/or the main server(s) 110 may pull and/or extract data/information from among the systems.

The main server(s) 110 of the management system 100 may include at least one processor, one or more interfaces (e.g., an electronic device including hardware circuitry, an application on an electronic device) for communication with other components within the management network 100 (e.g., user device(s) 101, entity system(s) 107, card processor system(s) 105, brokerage system(s) 180, etc.) and non-transitory memory storing one or more routines and or algorithms. In some examples, the main server(s) 110 may also include additional storage (e.g., one or more databases) for storing data and/or information associated with the various functions of the management system 100.

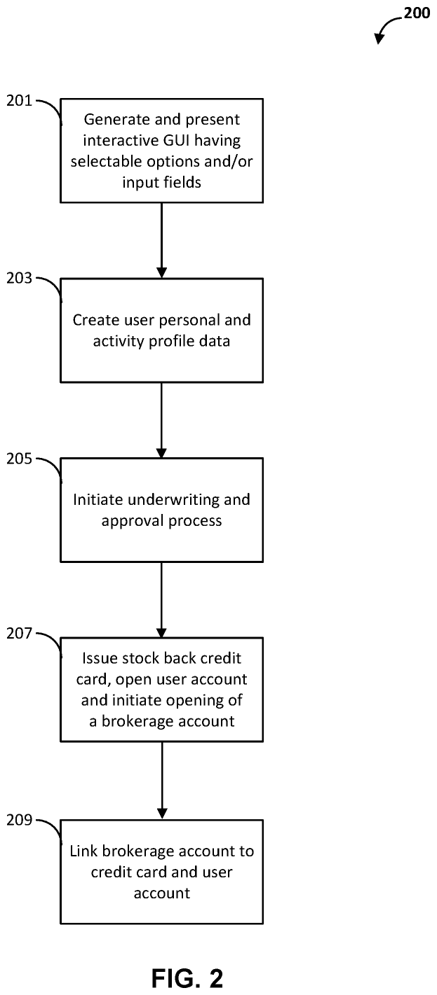

Turning now to FIG. 2, an exemplary opening process 200 implemented by an electronic account management system according to the present disclosure is shown. At step 201, the electronic account management system may generate and present to a user (e.g., via the interactive GUI 121) one or more selectable options (e.g., click boxes, drop-down menus, etc.) and/or input fields. These selectable options and/or input fields may collect information about a user's profile (e.g., income, financial objectives, financial profile, etc.), preferences (e.g., preferred stock characteristics, display features, credit card attributes, etc.), transaction activities (past, present and/or future), and the like.

At step 203, responses and data received may be used by the electronic account management system to create user personal and activity profile data. The responses and data may further be used by the electronic account management system to automatically initiate an underwriting and approval process (step 205). The underwriting and approval process 205 may include auto-populating one or more electronic application forms with the user personal and activity profile data, and submitting the applications forms to one or more underwriting systems for automated evaluation and/or approval. In some embodiments, the underwriting and approval process 205 may involve a combination of automated to human functions.

Once underwriting is completed and approval is granted (at step 205), the process 200 moves to step 207, where the electronic account management system issues a stock back credit card, opens a related user account, and initiates (e.g., by sending electronic instructions) the opening of a brokerage account for the user at one or more brokerage systems. At step 209, the newly-opened brokerage account is linked to the credit card and related user account, such that stock rewards earned as a result of transactions involving the credit card (discussed above) may be used to automatically fund the linked brokerage account.

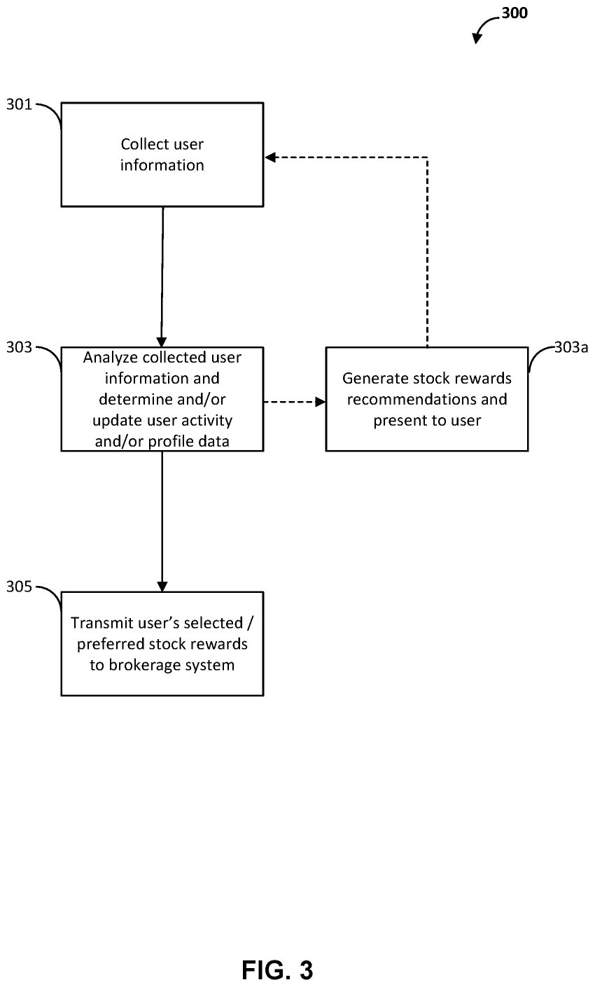

Turning now to FIG. 3, an exemplary onboarding process 300 that may be performed by components of the electronic account management system of the present disclosure is shown. Once a user's credit card is issued, a related user account is opened and a brokerage account is opened and linked to the credit card and user account (e.g., see process 200 of FIG. 2), the onboarding process 300 may commence. At step 301, the electronic account management system may collect information pertaining to the user. This may be done, for example, by generating and presenting to the user an interactive GUI that includes prompts and questions (e.g., a survey), input fields, selectable options, drop down menus, click boxes, etc. (to which the user provides direct input via the interactive GUI), by generating and transmitting electronic communications such as text messages, e-mails, etc. to the user (to which the user may respond using the user's communication device), by interrogating and extracting previously-collected data from a system database, and/or by monitoring the user's activity (e.g., transactions and non-transaction activities) via one or more of the electronic account management system's monitoring components.

At step 303, the electronic account management system may analyze the collected information to determine and/or update (among other things) the user's activity and/or profile data, which may include user-specific characteristics (e.g., user-specific financial goals, user spending habits, purchase profile/seasonality, etc.) and/or user-specific stock rewards characteristics (e.g., preferred stocks, preferred stock characteristics/categories, preferred stock rewards distribution, etc.).

In some embodiments, the process 300 may include step 303a, which includes generating one or more stock rewards recommendations and presenting them to the user. In some embodiments, a machine learning process may be used to generate analytics data, which in turn may be used to generate the stock rewards recommendations. For example, the machine learning process may include collecting information from the user (e.g., step 301), optionally combining it with previously-collected activity and/or profile data (of the user and/or other users) to create training data, and then using the training data to execute one or more machine learning models. Output from the machine learning models may include the analytics data that may then be used to generate the stock rewards recommendations in a manner reflect a combination of the user's input, the user's activities, and/or selections made by other users having similar activity and/or profile characteristics, for example. The stock rewards recommendations may then be presented to the user, and responses thereto may be collected (step 301) and used to update the user's activity and/or profile data (step 303).

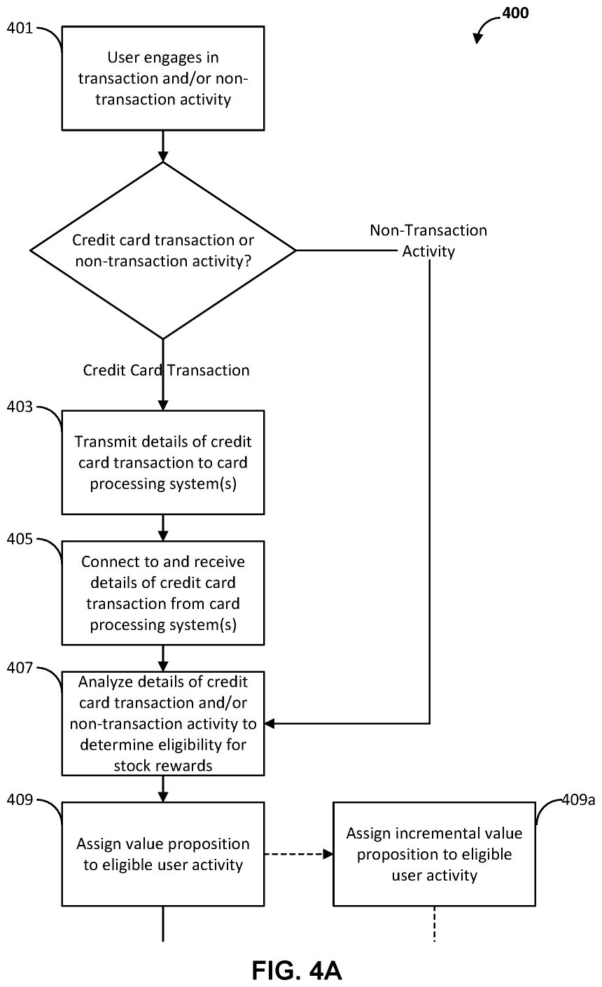

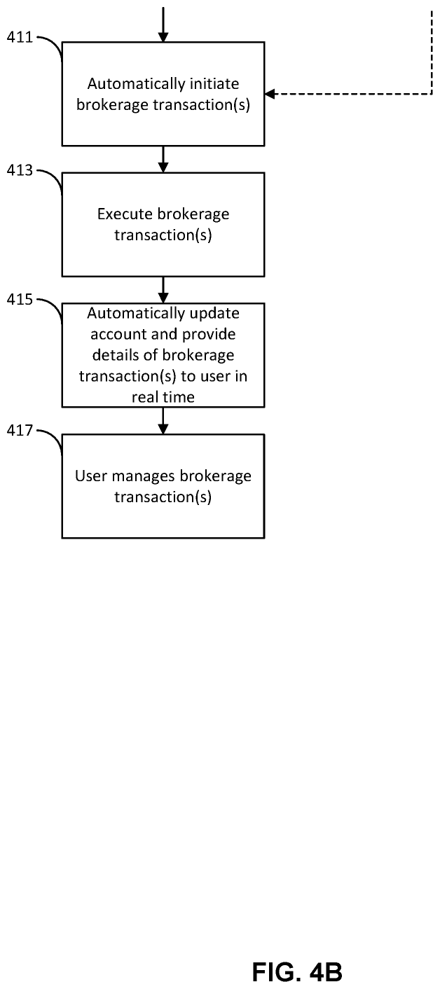

At step 305, the user's selected/preferred stock rewards may be transmitted to one or more brokerage systems, which may in turn, initiate brokerage transactions on behalf of the user, each time the user earns stock rewards (see e.g., FIG. 4).

Turning now to FIG. 4, an exemplary process 400 for determining and awarding stock rewards by components of the electronic account management system of the present disclosure is shown. At step 401, a user may engage in transaction and/or a non-transaction activity. In some embodiments, the electronic account management system may automatically monitor (continuously, repeatedly and/or at predetermined intervals) transaction activity of the user involving a stock back credit card (e.g., via direct communications with one or more card processor system(s) and/or one or more third party entity systems(s)), and non-transaction activity (e.g., via direct communications with one or more entity system(s)). In addition, the electronic account management system may monitor and/or become aware of the user's transaction and non-transaction activity by receiving direct user input (e.g., via an interactive GUI) and/or via one or more monitoring components of the electronic account management system.

If the user's activity involves a credit card transaction, the process 400 advances to step 403; otherwise, if the user's activity involves a non-transaction activity (e.g., setting up automatic bill pay, open a new account with the issuer of the credit card, add another user to the user's credit card account, etc.), the process 400 advances to step 407.

At step 403, details of the user's credit card transaction may be transmitted to one or more card processor systems; and at step 405, the electronic account management system may connect to and receive the details of the credit card transactions.

At step 407, details of the credit card transaction (from step 403) and/or the non-transaction activity (from step 401) may be analyzed by the electronic account management system to determine whether the user (by virtue of engaging in the credit card transaction and/or non-transaction activity) is eligible for certain stock rewards. This may be accomplished, for example, by comparing details and/or other characteristics of the credit card transaction and/or non-transaction activity against one or more predetermined stock rewards conditions, and then determining, based on the comparison, whether and which stock rewards the user is eligible for. In some embodiments, satisfying all predetermined conditions may be required to be eligible for certain stock rewards, while for certain other stock rewards, eligibility may be obtained by satisfying a combination of fewer than all predetermined conditions.

Once the electronic account management system determines that the user is eligible for one or more stock rewards (at step 407), the process 400 proceeds to step 409 where the electronic account management system may assign one or more predetermined value propositions to the credit card transaction and/or non-transaction activity of the user. In some embodiments, the value of stock rewards may be determined as a percentage of the value of the credit card transaction and/or non-transaction activity, as a fixed (per-activity) amount, as a variable amount, and/or based on any other valuation approach.

In some examples, the process 400 may include step 409a, where the electronic account management system may optionally assign an incremental value proposition to the credit card transaction and/or the non-transaction activity. This incremental value proposition would be in addition to the predetermined value propositions, thereby increasing the overall value propositions for the credit card transaction and/or non-transaction activity. Incremental value propositions may be awarded for satisfying any number of criteria, including (without limitation) if the credit card transaction and/or non-activity is made in response to a system-suggested incentive (engagement) activity, if the user has a pre-existing relationship with the issuer of the user's stock back credit card, etc.

It should also be noted that the user may earn a direct stock reward from a particular merchant (e.g., for engaging in a credit card transaction and/or non-transaction activity involving that particular merchant). This direct stock award may supplement the stock rewards value propositions determined by the electronic account management system, or a value of the direct stock award may be deducted from the value propositions determined by the electronic account management system.

Once the electronic account management system determines a value proposition (and any incremental value propositions) of stock rewards to be awarded to the user (at step 409-409a), the process 400 may proceed to step 411. At step 411, the electronic account management system may automatically initiate one or more brokerage transactions on behalf of the user, without a need for further input from the user. The one or more brokerage transactions may involve the purchase and/or sale of full shares and/or fractional shares of stock(s) previously selected by the user (e.g., during an onboarding process) and/or selected by the electronic account management system for the user.

In some embodiments, initiating the brokerage transactions (step 411) may include generating one or more electronic communications that include information relating to the value of stock rewards to be added to the user's brokerage account and instructions for executing the brokerage transactions on behalf of the user, and transmitting the electronic communications to one or more brokerage systems. In some embodiments, the one or more brokerage systems may be a part of the electronic account management system.

Next, at step 413, one or more brokerage systems may execute the one or more brokerage transactions on behalf of the user. The one or more brokerage transactions may be completely funded with the stock rewards awarded by the electronic account management system (e.g., as opposed to the user funding such brokerage transactions). In some embodiments, initiation of brokerage transactions may also occur in real-time or near real-time (e.g., as soon as the electronic account management system determines a value of stock rewards for the user).

At step 415, information reflecting the brokerage transactions (and their status) may automatically (e.g., in real-time or near real-time) be reflected in the user's account (i.e., the account associated with the user's credit card). The management system 100 may also generate and present information relating to the stock rewards and/or brokerage transactions directly to the user (e.g., via a text message, an email message, an alert, etc.) in real time (or near real time). In this manner the user may obtain an indication of any stock rewards and/or brokerage transactions substantially concurrently with the user's credit card transaction and/or non-transaction activity.

Optionally, at step 417, the user may manage the shares and/or fractional shares of stock resulting from the brokerage transactions executed on behalf of the user at step 413. For example, the user may directly initiate one or more ad hoc brokerage transaction requests to sell one or more shares and/or fractional shares of stock in the user's brokerage account. Funds resulting from the same (and/or funds from previous sales) may then be transferred to a different brokerage account of the user and/or to a non-brokerage account designated by the user.

Information relating to the brokerage transaction requests, the initiation of the brokerage transactions, the status of the brokerage transactions, updates to the user's brokerage account, transfers to the user's non-brokerage account (e.g., resulting from the brokerage transactions), etc. from step 417 may be captured and reported to the user in real time or near real-time (as in step 415).

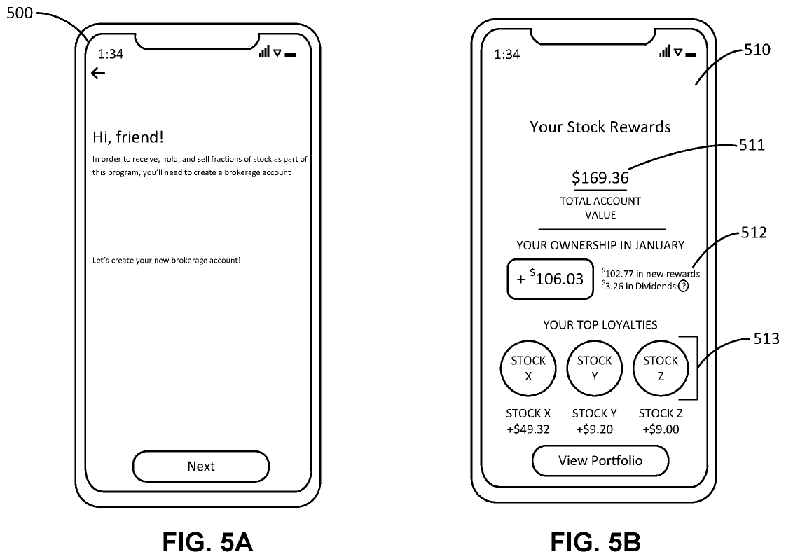

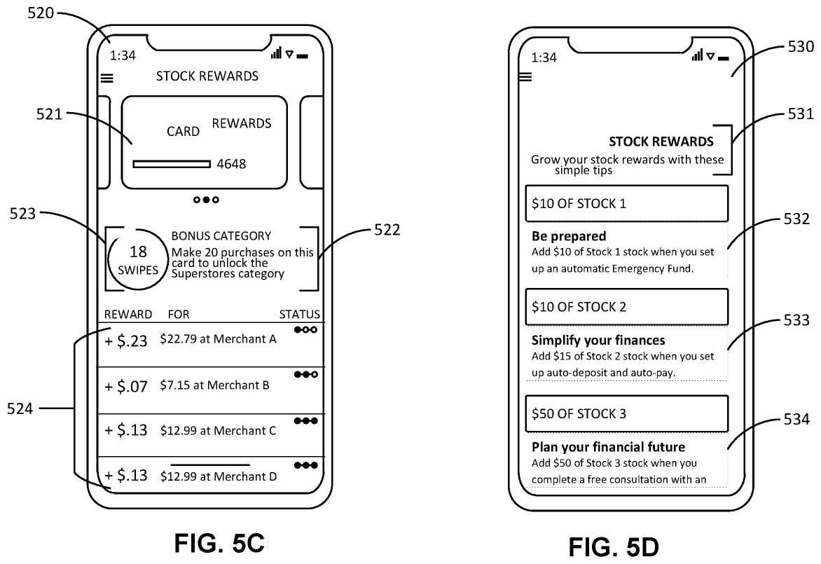

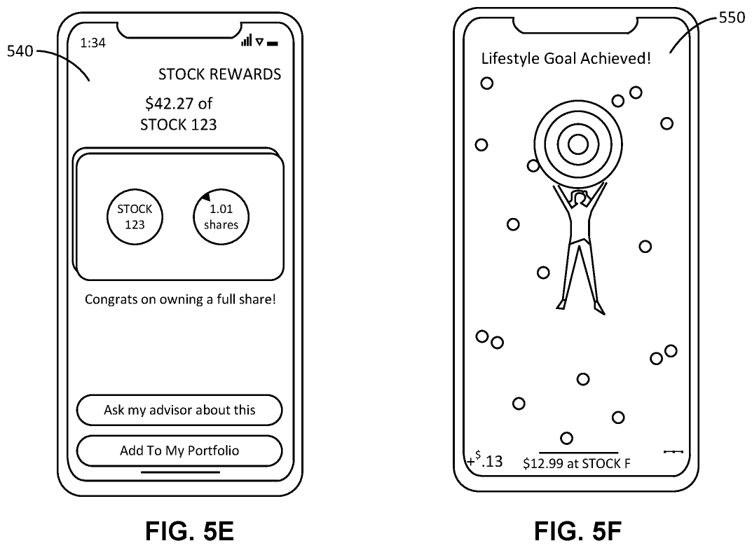

Turning now to FIGS. 5A-5F, exemplary screen shots of an interactive GUI for engaging with the electronic account management system of the present disclosure are shown. The exemplary screen shots 5A-5F are shown in connection with a mobile user device, however, it should be understood that similar screens may be configured for display and interaction on other types of user devices (e.g., tablet computers, laptop computers, desktop computers, servers, etc.).

FIG. 5A shows an exemplary interactive welcome screen 500 that may be accessed by a user to commence creating a customized stock back credit card and for engaging with the electronic account management system of the present disclosure. By selecting ‘Next’ (501), the welcome screen 500 takes the user to subsequent screens where the user may input profile and/or activity data and information. The user's profile and/or activity data and information may then be utilized by the electronic account management system to authorize and create a stock back credit card, a related user account and a linked brokerage account for the user, as discussed herein.

FIG. 5B includes an exemplary interactive display screen 510 showing accumulated stock rewards 511 earned by the user, stock rewards earned in a particular month (January) 512, and three (3) of the user's stock preferences 513. Selecting the interactive “View Portfolio” button 514 will take the user to another interactive screen that shows the user's entire stock portfolio (acquired via earned stock rewards).

FIG. 5C shows an exemplary interactive display screen 520 showing a system-generated incentive message 522, and the user's progress towards satisfying the incentive 523. In this example, the incentive message 522 advises the user that making 20 purchases using the user's stock back credit card (shown as an image 521) will unlock a new category of rewards (in this case, “Superstores category”). Since the user has already engaged in 18 transactions (shown as “18 swipes”) 523, the user only needs to make two additional credit card transactions to earn the Superstores category rewards. At the bottom of the interactive display screen 520, a portion 524 of the user's 18 transactions that count towards the threshold of 20 transactions is listed. The user may scroll the portion 524 to reveal more of the 18 transactions.

FIG. 5D shows an exemplary interactive display screen 530 suggesting non-transaction activities for growing the user's stock rewards 531. In this example, the user may earn $10 in shares or fractional shares of a first stock for setting up an automatic emergency fund 532. The user may also earn $15 in shares or fractional shares of a second stock for setting up auto-deposit and auto-pay functionality to the user's account 533. Lastly, in this example, the user may earn $50 in shares or fractional shares of a third stock for completing a free consultation with a financial advisor 534.

FIG. 5E shows an exemplary interactive display screen 540 confirming ownership of a full share of a particular stock (stock 123) purchased for the user using the user's earned stock rewards.

FIG. 5F shows an exemplary interactive display screen 550 advising the user that one or more particular lifestyle goals has been achieved. As discussed herein, the user's lifestyle goals may be included in the user's activity and/or profile data. Such information may be used by the electronic account management system of the present disclosure to generate activity suggestions (e.g., FIG. 5C) and incentives (e.g., FIG. 5D) that align with the user's lifestyle goals. In this example, the user has engaged in sufficient transactions and/or non-transaction activities to achieve one of the user's lifestyle goals.

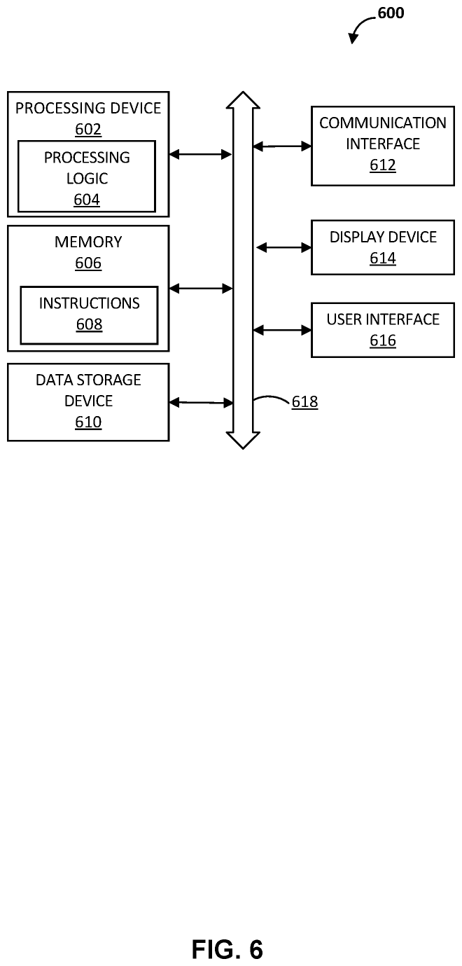

FIG. 6 illustrates a functional block diagram of a machine in the example form of computer system 600 within which a set of instructions for causing the machine to perform any one or more of the methodologies, processes or functions discussed herein may be executed. In some examples, the machine may be connected (e.g., networked) to other machines as described above. The machine may operate in the capacity of a server or a client machine in a client-server network environment, or as a peer machine in a peer-to-peer (or distributed) network environment. The machine may be any special-purpose machine capable of executing a set of instructions (sequential or otherwise) that specify actions to be taken by that machine for performing the functions describe herein. Further, while only a single machine is illustrated, the term “machine” shall also be taken to include any collection of machines that individually or jointly execute a set (or multiple sets) of instructions to perform any one or more of the methodologies discussed herein. In some examples, one or more components of the management system 100 (e.g., user-customizable card interface 120, interactive GUI 121, card/onboarding component 123, engagement component 125, card/engagement monitor 130, card/engagement analytics module 140, user activity monitor 150, etc.), user device(s) 101, card processor system(s) 105, entity system(s) 107, brokerage system(s) 180, etc., discussed above with reference to FIG. 1, may be implemented by a specialized machine, particularly programmed to perform certain functions, such as the example machine shown in FIG. 6 (or a combination of two or more of such machines).

Example computer system 600 may include processing device 602, memory 606, data storage device 610 and communication interface 612, which may communicate with each other via data and control bus 618. In some examples, computer system 600 may also include display device 614 and/or user interface 616.

Processing device 602 may include, without being limited to, a microprocessor, a central processing unit, an application-specific integrated circuit (ASIC), a field programmable gate array (FPGA), a digital signal processor (DSP) and/or a network processor. Processing device 602 may be configured to execute processing logic 604 for performing the operations described herein. Processing device 602 may include a special-purpose processing device specially programmed with processing logic 604 to perform the operations described herein.

Memory 606 may include, for example, without being limited to, at least one of a read-only memory (ROM), a random access memory (RAM), a flash memory, a dynamic RAM (DRAM) and a static RAM (SRAM), storing computer-readable instructions 608 executable by processing device 602. Memory 606 may include a non-transitory computer readable storage medium storing computer-readable instructions 608 executable by processing device 602 for performing the operations described herein. Although one memory device 606 is illustrated in FIG. 6, in some examples, computer system 600 may include two or more memory devices (e.g., dynamic memory and static memory).

Computer system 600 may include communication interface device 612, for direct communication with other computers (including wired and/or wireless communication) and/or for communication with a network. In some examples, computer system 600 may include display device 614 (e.g., a liquid crystal display (LCD), a touch sensitive display, etc.). In some examples, computer system 600 may include user interface 616 (e.g., an alphanumeric input device, a cursor control device, etc.).

In some examples, computer system 600 may include data storage device 610 storing instructions (e.g., software) for performing any one or more of the functions described herein. Data storage device 610 may include a non-transitory computer-readable storage medium, including, without being limited to, solid-state memories, optical media and magnetic media.

Some portions of the present disclosure describe embodiments in terms of algorithms and/or routines and symbolic representations of operations on information. These algorithmic descriptions and representations are used to convey the substance of this disclosure effectively to others skilled in the art. These operations, while described functionally, computationally, or logically, are to be understood as being implemented by data structures, computer programs or equivalent electrical circuits, microcode, or the like. Furthermore, at times, it may be convenient to refer to these arrangements of operations as routines or algorithms. The described operations and their routines/algorithms may be embodied in specialized software, firmware, specially-configured hardware or any combinations thereof.

The methods described herein (that may be conducted by the management system of the present disclosure) may be performed by processing logic that may comprise hardware (e.g., circuitry, dedicated logic, programmable logic, microcode, etc.), software (such as instructions run on a processing device), or a combination thereof. In one embodiment, the methods described herein may be performed by one or more specialized processing components.

Systems and methods of the present disclosure may include and/or may be implemented by one or more specialized computers including specialized hardware and/or software components. For purposes of this disclosure, a specialized computer may be a programmable machine capable of performing arithmetic and/or logical operations and specially programmed to perform the functions described herein. In some embodiments, computers may comprise processors, memories, data storage devices, and/or other components. These components may be connected physically or through network or wireless links. Computers may also comprise software which may direct the operations of the aforementioned components. Computers may be referred to as servers, personal computers (PCs), mobile devices, and other terms for computing/communication devices. For purposes of this disclosure, those terms used herein are interchangeable, and any special purpose computer particularly configured for performing the described functions may be used.

Computers may be linked to one another via one or more networks. A network may be any plurality of completely or partially interconnected computers wherein some or all of the computers are able to communicate with one another. Connections between computers may be wired in some cases (e.g., via wired TCP connection or other wired connection) or may be wireless (e.g., via a WiFi network connection). Any connection through which at least two computers may exchange data can be the basis of a network. Furthermore, separate networks may be able to be interconnected such that one or more computers within one network may communicate with one or more computers in another network. In such a case, the plurality of separate networks may optionally be considered to be a single network.

The term “computer” shall refer to any electronic device or devices, including those having capabilities to be utilized in connection with an electronic information/transaction system, such as any device capable of receiving, transmitting, processing and/or using data and information. The computer may comprise a server, a processor, a microprocessor, a personal computer, such as a laptop, palm PC, desktop or workstation, a network server, a mainframe, an electronic wired or wireless device, such as for example, a telephone, a cellular telephone, a personal digital assistant, a smartphone, an interactive television, such as for example, a television adapted to be connected to the Internet or an electronic device adapted for use with a television, an electronic pager or any other computing and/or communication device.

The term “network” shall refer to any type of network or networks, including those capable of being utilized in connection with the systems and methods described herein, such as, for example, any public and/or private networks, including, for instance, the Internet, an intranet, or an extranet, any wired or wireless networks or combinations thereof.

The term “computer-readable storage medium” should be taken to include a single medium or multiple media that store one or more sets of instructions. The term “computer-readable storage medium” shall also be taken to include any medium that is capable of storing or encoding a set of instructions for execution by the machine and that causes the machine to perform any one or more of the methodologies of the present disclosure.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

What is claimed is:

1. A system comprising
at least one user device associated with at least one user; and
at least one server in communication with the at least one user device, the server configured to:
generate an interactive graphical user interface (GUI) comprising one or more interactive screens for display on the at least one user device;
receive, from the at least one user device, via the interactive GUI, user input indicating user characteristics and stock rewards characteristics specific to the at least one user;
responsive to the indicated user characteristics and the stock rewards characteristics, create an electronic credit card and a brokerage account linked to the electronic credit card, the electronic credit card and the brokerage account associated with the at least one user and customized to the at least one user according to the user input;
monitor data from among one or more of at least one card processor system and at least one entity system for any changes in user activity associated with the at least one user, the user activity including a combination of transaction activity and non-transaction activity;
determine a stock rewards value to be applied to the brokerage account based on the monitored data; and
automatically initiate a brokerage transaction, funded by a stock rewards balance in the brokerage account, in accordance with the stock rewards characteristics associated with the at least one user.

2. The system of claim 1, wherein the at least one server, upon receiving a first portion of the user input, is further configured to:
combine the first portion of the user input with user input associated with one or more other users to generate training data;
execute a machine learning process using the training data;
automatically generate one or more prompts based on output from the machine learning process;
display the one or more prompts on the interactive GUI; and
receive, responsive to the one or more prompts, a second portion of the user input.

3. The system of claim 2, wherein the one or more prompts comprise one or more categories of stock rewards characteristics generated from the output of the machine learning process, and wherein the second portion of the user input includes a selection of at least one among the one or more categories of stock rewards characteristics.

4. The system of claim 1, wherein the at least one server is further configured to continually monitor the data from among one or more of at the least one card processor system and the at least one entity system and, responsive to detecting at least one change in the user activity associated with the at least one user, the at least one server is further configured to automatically update profile data associated with the at least one user, the profile data comprising one or more of the user characteristics and the stock rewards characteristics specific to the at least one user.

5. The system of claim 1, wherein the at least one server is further configured to:
determine a usage by the at least one user of said system; and
automatically award an incremental value to one or more among the determined stock rewards values based on said usage, the usage determined based on current usage data and historical usage data stored in a system memory.

6. The system of claim 1, wherein the at least one server is further configured to generate and display earned stock rewards, in real-time, as said stock rewards are earned.

7. The system of claim 1, wherein the at least one server is further configured to:
monitor activity data associated with one or more other users, and store the activity data associated with the one or more other users in a database;
combine the monitored data associated with the at least one user with the activity data associated with the one or more other users to create training data;
execute a machine learning process using the training data;
automatically generate one or more suggestions based on output from the machine learning process;
display the one or more suggestions on the interactive GUI; and
associate additional stock rewards values to the one or more suggestions such that completion of the one or more suggestions results in an award of the additional stock rewards values.

8. The system of claim 7, wherein the at least one server is further configured to:
automatically update the training data and re-execute the machine learning process upon detecting a change in one or more of the monitored data associated with the at least one user and the monitored activity data associated with the one or more other users; and
automatically generate and display updated suggestions based on output of the re-executed machine learning process,
the updated suggestions arranged on the interactive GUI according to a frequency at which each updated suggestion is completed.

9. The system of claim 7, wherein the at least one server is further configured to automatically generate and transmit an alert to the at least one user device upon the occurrence of one or more of: an update to available stock rewards, an availability of or a change to one or more system-generated suggestions, a change in monitored data associated with the at least one user, a change in user activity data associated with one or more other users, a goal progressing of the at least one user, a change to one or more of the user characteristics and the stock rewards characteristics, and a status of the brokerage transaction.

10. The system of claim 7, wherein the one or more suggestions includes one or more engagement activities, completion of which results in earned stock rewards.

11. The system of claim 10, wherein the one or more engagement activities includes one or more system-generated incentive or promotional activities.

12. The system of claim 11, wherein completion of at least one among the one or more suggestions results in an incremental stock rewards value proposition.

13. The system of claim 11, wherein completion of at least one among the one or more suggestions results in a direct fractional stock award from one or more merchants.

14. The system of claim 1, wherein the at least one server is further configured to determine the stock rewards value based on a fixed, predetermined rewards value or as a variable rewards value that changes over time according to one or more variable conditions.

15. The system of claim 1, wherein the at least one user device comprises one or more of a mobile phone, a smart phone, a tablet computer, a desktop computer, a server computer.

16. A computer-implemented method comprising:
generating, by a system comprising at least one server, an interactive graphical user interface (GUI) comprising one or more interactive screens for display on at least one user device,
the system further comprising a memory storing computer-readable instructions and a processor executing the computer-readable instructions,
the at least one user device in communication with the at least one server via one or more communications networks;
receiving, by the at least one server from the at least one user device, via the interactive GUI, user input indicating user characteristics and stock rewards characteristics specific to the at least one user;
creating, by the at least one server responsive to the indicated user characteristics and the stock rewards characteristics, an electronic credit card and a brokerage account linked to the electronic credit card, the electronic credit card and the brokerage account associated with the at least one user and customized to the at least one user according to the user input;
monitoring, by the at least one server, data from among one or more of at least one card processor system and at least one entity system for any changes in user activity associated with the at least one user, the user activity including a combination of transaction activity and non-transaction activity;
determining, by the at least one server, a stock rewards value to be applied to the brokerage account based on the monitored data; and
automatically initiating, by the at least one server, a brokerage transaction, funded by a stock rewards balance in the brokerage account, in accordance with the stock rewards characteristics associated with the at least one user.

17. The method of claim 16, further comprising:
the at least one server, upon receiving a first portion of the user input, performs the steps of:
combining the first portion of the user input with user input associated with one or more other users to generate training data;
executing a machine learning process using the training data;
automatically generating one or more prompts based on output from the machine learning process;
displaying the one or more prompts on the interactive GUI; and
receiving, responsive to the one or more prompts, a second portion of the user input.

18. The method of claim 17, wherein the one or more prompts comprise one or more categories of stock rewards characteristics generated from the output of the machine learning process, and wherein the second portion of the user input includes a selection of at least one among the one or more categories of stock rewards characteristics.

19. The method of claim 16, further comprising:
continually monitoring, by the least one server, the data from among one or more of at the least one card processor system and the at least one entity system; and
automatically updating, by the at least one server responsive to detecting at least one change in the user activity associated with the at least one user, profile data associated with the at least one user, the profile data comprising one or more of the user characteristics and the stock rewards characteristics specific to the at least one user.

20. The method of claim 16, further comprising:
determining, by the at least one server, a usage by the at least one user of said system; and
automatically award an incremental value to one or more among the determined stock rewards values based on said usage, the usage determined from current and historical usage data stored in the system's memory.

21. The method of claim 16, further comprising:
generating and displaying, by the at least one server, earned stock rewards in real-time as said stock rewards are earned by the at least one user.

22. The method of claim 16, further comprising:
monitoring, by the at least one server, activity data associated with one or more other users, and store the activity data associated with the one or more other users in a database;
combining, by the at least one server, the monitored data associated with the at least one user with the activity data associated with the one or more other users to create training data;
executing, by the at least one server, a machine learning process using the training data;
automatically generating, by the at least one server, one or more suggestions based on output from the machine learning process;
displaying, by the at least one server, the one or more suggestions on the interactive GUI; and
associating, by the at least one server, additional stock rewards values to the one or more suggestions such that completion of the one or more suggestions results in an award of the additional stock rewards values.

23. The method of claim 22, further comprising:
automatically updating, by the at least one server, the training data;
re-executing, by the at least one server, the machine learning process upon detecting a change in one or more of the monitored data associated with the at least one user and the monitored activity data associated with the one or more other users; and
automatically generating and displaying, by the at least one server, updated suggestions based on output of the re-executed machine learning process,
the updated suggestions arranged on the interactive GUI according to a frequency at which each updated suggestion is completed.

24. The method of claim 22, further comprising:
automatically generating and transmitting, by the at least one server, an alert to the at least one user device upon the occurrence of one or more of: an update to available stock rewards, an availability of or a change to one or more system-generated suggestions, a change in monitored data associated with the at least one user, a change in user activity data associated with one or more other users, a goal progressing of the at least one user, a change to one or more of the user characteristics and the stock rewards characteristics, and a status of the brokerage transaction.

25. The method of claim 22, wherein the one or more suggestions includes one or more engagement activities, completion of which results in earned stock rewards.

26. The method of claim 25, wherein the one or more engagement activities includes one or more system-generated incentive or promotional activities.

27. The method of claim 26, wherein completion of at least one among the one or more suggestions results in an incremental stock rewards value proposition.

28. The method of claim 26, wherein completion of at least one among the one or more suggestions results in a direct fractional stock award from one or more merchants.

29. The method of claim 16, further comprising:
determining, by the at least one server, the stock rewards value based on a fixed, predetermined rewards value or as a variable rewards value that changes over time according to one or more variable conditions.

30. The method of claim 16, wherein the at least one user device comprises one or more of a mobile phone, a smart phone, a tablet computer, a desktop computer, a server computer.
